(19) United States
(12) Patent Application Publication
(10) Pub. No.: US 2015/0120461 A1
(43) Pub. Date: Apr. 30, 2015

(54) INFORMATION PROCESSING SYSTEM

(71) Applicant: BIGLOBE INC., Tokyo (JP)

(72) Inventor: Michitaro Miyata, Tokyo (JP)

(73) Assignee: BIGLOBE INC., Tokyo (JP)

(21) Appl. No.: 14/387,172

(22) PCT Filed: Dec. 7, 2012
(86) PCT No.: PCT/JP2012/081793

§ 371 Date: Sep. 22, 2014

(30) Foreign Application Priority Data
Mar. 23, 2012 (JP) 2012-067551

(51) Int. Cl. G06Q 30/02; G06Q 30/06; G06K 7/10; G06K 17/00; G06K 7/00

(52) U.S. Cl. CPC G06Q 30/0267; G06K 17/00; G06K 7/00; G06K 7/10; G06Q 30/0601
USPC 705/14.64

(57) ABSTRACT

A communication terminal (300) generates a space coordinate system on the basis of the relative positions of identification images in a first image acquired by photographing a tag array board (100) using a camera-attached glasses (200) and transmits the coordinate range of the space coordinate system included in the first image to a commodity management server (500); the commodity management server (500) transmits a second image and display coordinates corresponding to the space coordinate system to the communication terminal (300); the communication terminal (300) displays the second image at the position based on the display coordinates of the camera-attached glasses (200), reads a tag ID from the tag array board (100) and transmits the tag ID to the commodity management server (500); and the commodity management server (500) performs predetermined processing on the basis of the tag ID.

### TECHNICAL FIELD

The present invention relates to an information processing system, a photographing display apparatus, a communication terminal, a server, an information providing medium, an information processing method and a program for transferring electronic information.

### BACKGROUND ART

In recent years, a technology for displaying image information based on information written in an IC tag attached to an advertising medium on a mobile terminal has been devised (for example, refer to Patent Document 1). More specifically, first, a mobile terminal equipped with a tag reader function reads information written in an IC tag attached to an advertising medium. Next, the mobile terminal transmits the read information to a server. Then, on the basis of the information, the server generates image information and transmits the image information to the mobile terminal. Furthermore, the mobile terminal displays the image information transmitted from the server.

### PRIOR ART REFERENCE

### Patent Document

Patent Document 1: JP-A-2009-288825

### SUMMARY OF INVENTION

### Problems to be Solved by the Invention

However, in the above-mentioned technology, the same image is displayed at all times on the advertising medium, whereby there is a problem that flexible information provision cannot be carried out.

An object of the present invention is to provide an information processing system, a photographing display apparatus, a communication terminal, a server, an information providing medium, an information processing method and a program for solving the above-mentioned problem.

### Means for Solving to the Problems

The information processing system according to the present invention is equipped with:

an information providing medium, on one face of which information storage media in which tag identification information has been written are disposed, and on the face of which predetermined identification images are displayed,

a photographing display apparatus for photographing at least part of the face of the information providing medium on which the information storage media are disposed,

a communication terminal for identifying the identification images in a first image photographed by the photographing display apparatus, for generating a space coordinate system on the basis of the relative positions of the identification images in the first image, and for transmitting the coordinate range of the generated space coordinate system, and

a server for transmitting a second image corresponding to the coordinate range transmitted from the communication terminal and the display coordinates for displaying the second image to the communication terminal, wherein

the communication terminal displays the second image transmitted from the server at the position based on the display coordinates of the photographing display apparatus, reads the tag identification information from the information storage media, and transmits the read tag identification information to the server, and

the server performs predetermined processing on the basis of the tag identification information transmitted from the communication terminal.

Furthermore, the information processing system according to the present invention is equipped with:

an information providing medium, on one face of which information storage media in which tag identification information has been written are disposed, and on the face of which predetermined identification images are displayed,

a photographing display apparatus for photographing at least part of the face of the information providing medium on which the information storage media are disposed,

a communication terminal for acquiring a first image photographed by the photographing display apparatus and for transmitting the acquired first image, and

a server for transmitting a second image corresponding to the first image transmitted from the communication terminal and the display coordinates for displaying the second image to the communication terminal, wherein

the communication terminal displays the second image transmitted from the server at the position based on the display coordinates of the photographing display apparatus, reads the tag identification information from the information storage media, and transmits the read tag identification information to the server, and

the server performs predetermined processing on the basis of the tag identification information transmitted from the communication terminal.

Moreover, the photographing display apparatus according to the present invention is equipped with:

a photographing section,

a communication section for transmitting the first image photographed by the photographing section, and

a display section for displaying the second image transmitted from the communication terminal.

What's more, the communication terminal according to the present invention is equipped with:

an acquisition section for acquiring a first image photographed by the photographing display apparatus connected to the communication terminal,

a space coordinate system generation section for identifying predetermined identification images in the first image acquired by the acquisition section and for generating a space coordinate system on the basis of the relative positions of the identification images in the first image,

a communication section for transmitting the coordinate range on the space coordinate system generated by the space coordinate system generation section to the server connected to the communication terminal,

a display control section, in the case that a second image and display coordinates have been transmitted from the server, for displaying the second image at the position based on the display coordinates of the photographing display apparatus, and

an information reading section for reading tag identification information from information storage media provided externally, wherein

the communication section transmits the tag identification information read by the information reading section to the server.

Besides, the server according to the present invention is equipped with;

a database for storing tag identification information and coordinates so as to correspond mutually, for storing the tag identification information and commodities or service and object identification information indicating processing functions so as to correspond mutually, and for storing the object identification information and object images so as to correspond mutually,

a retrieval section for retrieving the tag identification information on the basis of the coordinate range transmitted from the communication terminal connected to the server, for retrieving the object identification information on the basis of the retrieved tag identification information, and for retrieving the object images on the basis of the retrieved object identification information, using the database,

a communication section for transmitting the object images retrieved by the retrieval section and the display coordinates for displaying the object images to the communication terminal, and

a control section for performing predetermined processing on the basis of the tag identification information transmitted from the communication terminal.

Still further, the server according to the present invention is equipped with:

a space coordinate system generation section for identifying predetermined identification images in the first image transmitted from the communication terminal connected to the server, and for generating a space coordinate system in the first image on the basis of the relative positions of the identification images in the first image,

a communication section for transmitting the second image and the display coordinates corresponding to the space coordinate system generated by the space coordinate system generation section, and

a control section for performing predetermined processing on the basis of the tag identification information transmitted from the communication terminal.

In addition, the information providing medium according to the present invention is:

an information providing medium, on one face of which information storage media in which tag identification information has been written are disposed, and on the face of which predetermined identification images are displayed.

Furthermore, an information processing method according to the present invention in an information processing system equipped with an information providing medium, on one face of which information storage media in which tag identification information has been written are disposed, and on the face of which predetermined identification images are displayed, performing the processes of:

photographing at least part of the face of the information providing medium on which the information storage media are disposed, using the photographing display apparatus,

identifying the identification images in a first image photographed by the photographing display apparatus, using the communication terminal,

generating a space coordinate system on the basis of the relative positions of the identification images in the first image, using the communication terminal,

transmitting the coordinate range of the generated space coordinate system to the server, using the communication terminal,

transmitting a second image corresponding to the coordinate range transmitted from the communication terminal and the display coordinates for displaying the second image to the communication terminal, using the server,

displaying the second image transmitted from the server at the position based on the display coordinates of the photographing display apparatus, using the communication terminal,

reading the tag identification information from the information storage media, using the communication terminal,

transmitting the read tag identification information to the server, using the communication terminal, and

performing predetermined processing on the basis of the tag identification information transmitted from the communication terminal, using the server.

Moreover, an information processing method according to the present invention in an information processing system equipped with an information providing medium, on one face of which information storage media in which tag identification information has been written are disposed, and on the face of which predetermined identification images are displayed, performing the processes of

photographing at least part of the face of the information providing medium on which the information storage media are disposed, using the photographing display apparatus,

acquiring a first image photographed by the photographing display apparatus, using the communication terminal,

transmitting the acquired first image to the server, using the communication terminal,

transmitting a second image corresponding to the first image transmitted from the communication terminal and the display coordinates for displaying the second image to the communication terminal, using the server,

displaying the second image transmitted from the server at the position based on the display coordinates of the photographing display apparatus, using the communication terminal,

reading the tag identification information from the information storage media, using the communication terminal,

transmitting the read tag identification information to the server, using the communication terminal, and

performing predetermined processing on the basis of the tag identification information transmitted from the communication terminal, using the server.

What's more, a program according to the present invention is a program for making a communication terminal to execute the steps of:

acquiring a first image from the photographing display apparatus connected to the communication terminal,

identifying predetermined identification images in the acquired first image, generating a space coordinate system on the basis of the relative positions of the

identification images in the first image,

transmitting the coordinate range on the generated space coordinate system to the server connected to the communication terminal,

in the case that a second image and display coordinates have been transmitted from the server, displaying the second image at the position based on the display coordinates of the photographing display apparatus,

reading tag identification information from information storage media provided externally, and

transmitting the read tag identification information to the server.

Still further, a program according to the present invention is a program for making a computer to execute the steps of:

retrieving tag identification information, on the basis of the coordinate range transmitted from the communication terminal connected to the computer, from a tag position database in which the tag identification information and coordinates are stored so as to correspond mutually,

retrieving commodity identification information, on the basis of the retrieved tag identification information, from a corresponding commodity database in which the tag identification information and the commodity identification information are stored so as to correspond mutually,

retrieving a commodity image, on the basis of the retrieved commodity identification information, from a commodity information database in which the commodity identification information, the commodity information and the commodity image are stored so as to correspond mutually,

transmitting the retrieved commodity image and the display coordinates for displaying the commodity image to the communication terminal, and

performing predetermined processing on the basis of the tag identification information transmitted from the communication terminal.

Additionally, a program according to the present invention is a program for making a computer to execute the steps of:

identifying predetermined identification images in the first image transmitted from the communication terminal connected to the computer,

generating a space coordinate system in the first image on the basis of the relative positions of the identified identification images in the first image,

transmitting a second image corresponding to the generating space coordinate system and the display coordinates for displaying the second image to the communication terminal, and

performing predetermined processing on the basis of the tag identification information transmitted from the communication terminal.

### Advantageous Effects of the Invention

As described above, the present invention can perform flexible information provision.

### BRIEF DESCRIPTION OF THE DRAWINGS

FIG. 1 is a view showing a first embodiment of an information processing system of the present invention;

FIG. 2 is a view showing an example of the external appearance of the tag array board shown in FIG. 1;

FIG. 3 is a view showing an example of the internal configuration of the camera-attached glasses shown in FIG. 1;

FIG. 4 is a view showing an example of the internal configuration of the communication terminal shown in FIG. 1;

FIG. 5 is a view showing an example of the space coordinate system generated by the space coordinate system generation section shown in FIG. 4;

FIG. 6 is a view showing an example of the internal configuration of the commodity management server shown in FIG. 1;

FIG. 7 is a view showing an example of the correspondence stored in the tag position database shown in FIG. 6;

FIG. 8 is a view showing an example of the correspondence stored in the corresponding commodity database shown in FIG. 6;

FIG. 9 is a view showing an example of the correspondence stored in the commodity information database shown in FIG. 6;

FIG. 10 is a sequence diagram illustrating an information processing method according to the first embodiment shown in FIG. 1;

FIG. 11 is a view showing an example of an acquired photographed image;

FIG. 12 is a view showing another example of an acquired photographed image;

FIG. 13 is a view showing an example of commodity images viewed by the user wearing the camera-attached glasses;

FIG. 14 is a view showing an example of a screen seen by the user when the user brings the communication terminal close to the position on the tag array board in which a desired commodity image has been displayed, according to the images that can be seen;

FIG. 15 is a view showing an example of the arrangement of the IC tags in which the positions in which the IC tags on the tag array board are disposed and the positions in which the commodity images are displayed (the positions in which the commodity images can be seen by the user wearing the camera-attached glasses) are mutually different;

FIG. 16 is a view showing an example of images that can be seen from the user wearing the camera-attached glasses in the case that IC tags are arranged as shown in FIG. 15 and when the commodity images are displayed;

FIG. 17 is a view showing an example of the conversion between the coordinates of a photographed image (first image) and the coordinates of the virtual space in the case that the coordinate system generated by the space coordinate system generation section shown in FIG. 4 is three-dimensional;

FIG. 18 is a view showing an example in which the space coordinate system generation section shown in FIG. 4 generates the coordinates of the virtual space on the basis of the mutual distances and relative positions (including angles) of the markers;

FIG. 19 is a view showing an example in which the space coordinate system generation section shown in FIG. 4 generates the coordinates of the virtual space on the basis of the shapes of the markers;

FIG. 20 is a view showing an example in which the space coordinate system generation section generates the coordinates of the virtual space on the basis of the commodity image;

FIG. 21 is a view showing a second embodiment of the information processing system of the present invention;

FIG. 22 is a view showing an example of the internal configuration of the communication terminal shown in FIG. 21;

FIG. 23 is a view showing an example of the internal configuration of the commodity management server shown in FIG. 21;

FIG. 24 is a sequence diagram illustrating the information processing method according to the second embodiment shown in FIG. 21;

FIG. 25 is an example of an image that can be seen when a user, who has reserved a conference room for a glasses conference, wears the camera-attached glasses and views the tag array board; and

FIG. 26 is an example of an image that can be seen when a user other than the user who has reserved the conference room for the glasses conference wears the camera-attached glasses and views the tag array board.

### DESCRIPTION OF THE EMBODIMENTS

Embodiments according to the present invention will be described below referring to the drawings.

### First Embodiment

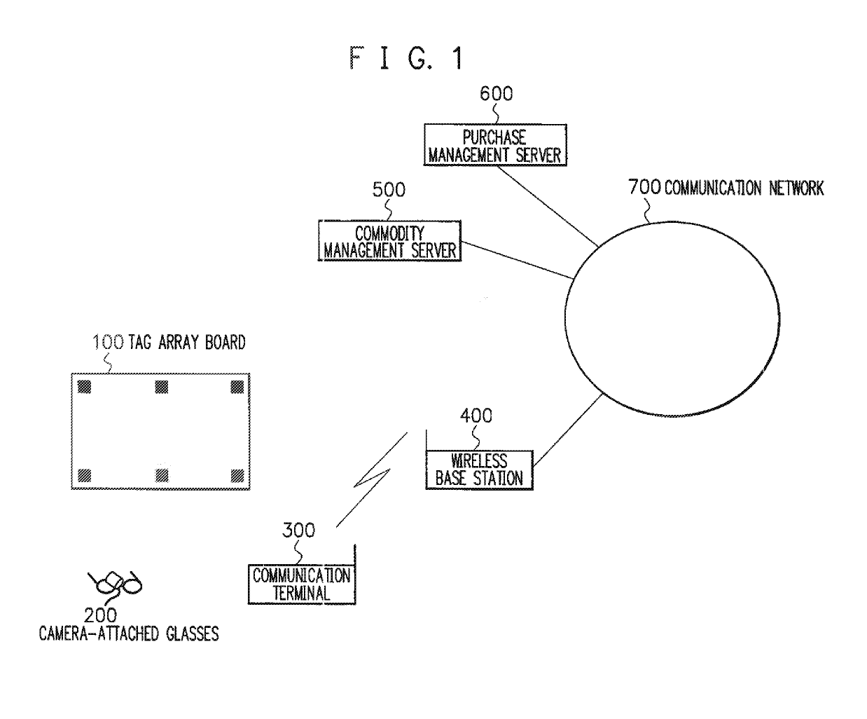

FIG. 1 is a view showing a first embodiment of an information processing system of the present invention.

As shown in FIG. 1, the information processing system according to this embodiment is provided with a tag array board 100, camera-attached glasses 200, a communication terminal 300, a wireless base station 400, a commodity management server 500, and a purchase management server 600. Furthermore, the wireless base station 400, the commodity management server 500 and the purchase management server 600 are connected mutually via a communication network 700.

The tag array board 100 is an information providing medium, on one face of which information storage media in which tag identification information has been written are arranged in a predetermined sequence, and on the face of which predetermined identification images are displayed. The tag array board 100 may be a plate-like medium or a paper-like medium, the material of which is not specified particularly.

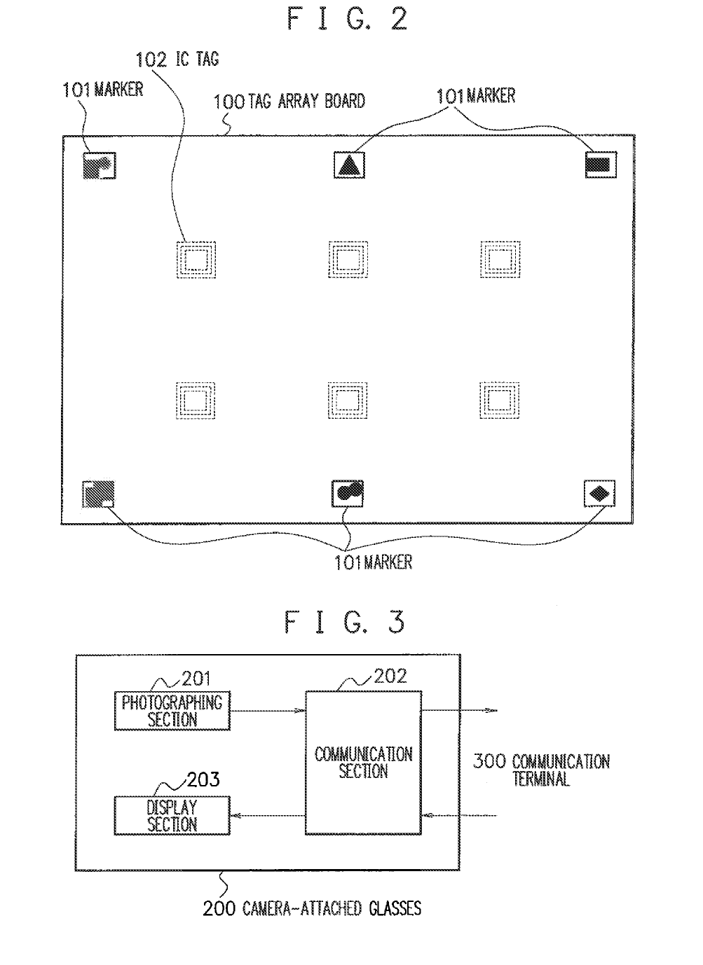

FIG. 2 is a view showing an example of the external appearance of the tag array board 100 shown in FIG. 1.

As shown in FIG. 2, on the tag array board 100 shown in FIG. 1, markers 101 serving as a plurality of identification images are displayed, and IC (Integrated Circuit) tags 102 serving as information storage media in which tag identification information has been written are disposed. Although a case in which six markers 101 and six IC tags 102 are provided is shown as an example in FIG. 2, the numbers thereof are not limited. The marker 101 has a predetermined shape. In addition, the marker 101 is made identifiable so that a space coordinate system is generated by the communication terminal 300 or the commodity management server 500. Furthermore, in the respective IC tags 102, tag identification information according to which the respective IC tags can be identified has been written preliminarily. What's more, the IC tags 102 can perform short-range wireless communication using a technology such as RFID (Radio Frequency Identification).

Moreover, the camera-attached glasses 200 is a photographing display apparatus for photographing at least part of the face of the tag array board 100 on which the IC tags 102 are disposed. In addition, the camera-attached glasses 200 displays information, such as an image, at the position indicated, by specified coordinates under the control of the communication terminal 300. The camera-attached glasses 200 may be an optical see-through type, in which a transmission type display is used, wherein an actual scene being seen actually and information being displayed can be seen in an overlapped state. Furthermore, the camera-attached glasses 200 may be a device for displaying an image (first image) acquired by photographing an actual scene and for displaying the first image and information (second image) displayed under the control of the communication terminal 300 in an overlapped state while a real field of vision is blocked.

FIG. 3 is a view showing an example of the internal configuration of the camera-attached glasses 200 shown in FIG. 1.

As shown in FIG. 3, the camera-attached glasses 200 shown in FIG. 1 is provided with a photographing section 201, a communication section 202 and a display section 203.

The photographing section 201 is a camera for photographing the tag array board 100 serving as an object to be photographed.

The communication section 202 transmits the first image photographed by the photographing section 201 to the communication terminal 300.

The display section 203 displays the second image transmitted from the communication terminal 300 on the basis of an instruction (for example, a display position) from the communication terminal 300.

The communication terminal 300 identifies the markers 101 in the first image photographed by the camera-attached glasses 200 and generates a space coordinate system on the basis of the relative positions of the markers 101 in the first image. In addition, the communication terminal 300 transmits the generated space coordinate system to the commodity management server 500 via the wireless base station 400 and the communication network 700. Furthermore, the communication terminal 300 displays the second image transmitted from the commodity management server 500 at the position based on the display coordinates of the camera-attached glasses 200. What's more, the communication terminal 300 has a tag reader function and reads the tag identification information from the IC tags 102 disposed on the tag array board 100. Moreover, the communication terminal 300 transmits the read tag identification information to the commodity management server 500 via the wireless base station 400 and the communication network 700.

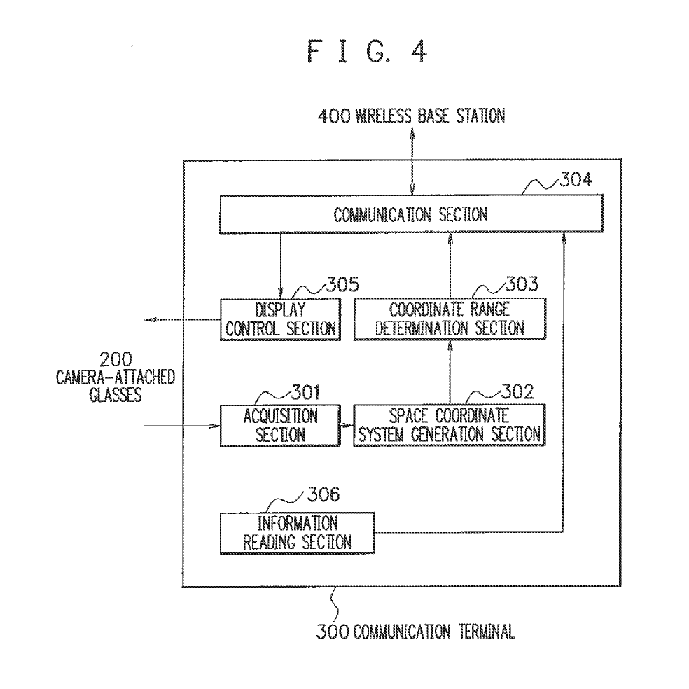

FIG. 4 is a view showing an example of the internal configuration of the communication terminal 300 shown in FIG. 1.

As shown in FIG. 4, the communication terminal 300 shown in FIG. 1 is provided with an acquisition section 301, a space coordinate system generation section 302, a coordinate range determination section 303, a communication section 304, a display control section 305, and an information reading section 306.

The acquisition section 301 acquires the first image photographed by the camera-attached glasses 200. The method for acquisition may be, for example, a method in which acquisition is performed between the acquisition section 301 and the camera-attached glasses 200 using wireless communication, such as Bluetooth (registered trademark) or wireless LAN (Local Area Network), or wired communication, and the method is not specified particularly. Furthermore, acquisition section 301 outputs the acquired first image to the space coordinate system generation section 302.

The space coordinate system generation section 302 identifies the markers 101 serving as predetermined identification images in the first image output from the acquisition section 301. Furthermore, the space coordinate system generation section 302 generates a space coordinate system serving as the coordinate system of the tag array board 100 in a virtual space on the basis of the relative positions of the markers 101 in the first image.

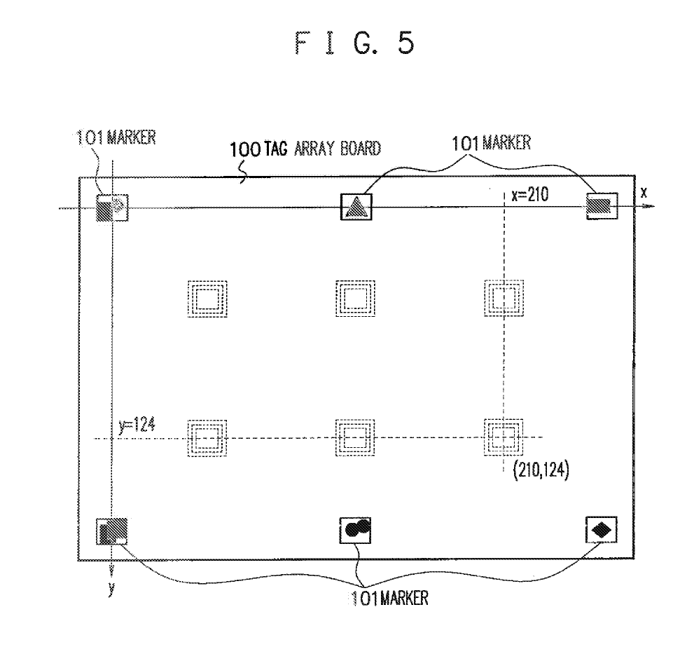

FIG. 5 is a view showing an example of the space coordinate system generated by the space coordinate system generation section 302 shown in FIG. 4.

As shown in FIG. 5, the space coordinate system generation section 302 identifies six markers 101, determines an x-coordinate axis and a y-coordinate axis on the basis of the positions, shapes, mutual distances and relative positions (including angles) of the identified six markers 101, and generates a space coordinate system from the respective coordinate axes. The space coordinate system generation section 302 has preliminarily recognized that the six markers 101 are identification images for generating the space coordinate system.

In addition, the space coordinate system generation section 302 obtains the correspondence relationship between the generated space coordinate system and the coordinates of the photographed image (first image) and outputs conversion equations expressing the corresponding relationship to the coordinate range determination section 303.

The coordinate range determination section 303 determines the coordinate range of the space coordinate system included in the photographed image (first image) using the conversion equations output from the space coordinate system generation section 302. In other words, the coordinate range determination section 303 determines the range of the first image photographed by the camera-attached glasses 200 in the space coordinate system that can be generated using the entire tag array board 100. This determination is performed, in the case that the camera-attached glasses 200 photographed part of the tag array board 100, to judge which part of the tag array board 100 was photographed on the basis of the markers 101 in the photographed first image. In addition, the coordinate range determination section 303 outputs the coordinate range of the space coordinate system included in the first image to the communication section 304.

The communication section 304 transmits the coordinate range of the space coordinate system included in the first image output from the coordinate range determination section 303 to the commodity management server 500 via the wireless base station 400 and the communication network 700. In other words, the communication section 304 transmits the coordinate range of the tag array board 100 in the photographed virtual space to the commodity management server 500 via the wireless base station 400 and the communication network 700. In addition, the communication section 304 receives the second image and display coordinates transmitted from the commodity management server 500 and outputs the received second image and display coordinates to the display control section 305. Furthermore, the communication section 304 transmits the tag identification information output from the information reading section 306 to the commodity management server 500 via the wireless base station 400 and the communication network 700. When transmitting the above-mentioned coordinate range, the communication section 304 may transmit the communication terminal identification information given to the communication terminal 300 together with these.

The display control section 305 displays the second image output from the communication section 304 at the position based on the display coordinates (output from the communication section 304) of the camera-attached glasses 200.

The information reading section 306 is a reader for reading the tag identification information from the IC tags 102 serving as the information storage media provided externally. Furthermore, the information reading section 306 outputs the read tag identification information to the communication section 304.

The wireless base station 400 is a general wireless base station, performs wireless communication with the communication terminal 300, and performs wired or wireless communication with the communication network 700.

The commodity management server 500 is a server for retrieving the second image according to the coordinate range transmitted from the communication terminal 300. At this time, in the case that the communication terminal identification information is transmitted together with the coordinate range from the communication terminal 300, the commodity management server 500 may retrieve the second image corresponding to the coordinate range and the communication terminal identification information. Furthermore, the commodity management server 500 may retrieve the second image according to the time of the retrieval. Moreover, the commodity management server 500 transmits the retrieved second image and the display coordinates for displaying the second image to the communication terminal 300. What's more, the commodity management server 500 performs predetermined processing on the basis of the tag identification information transmitted from the communication terminal 300.

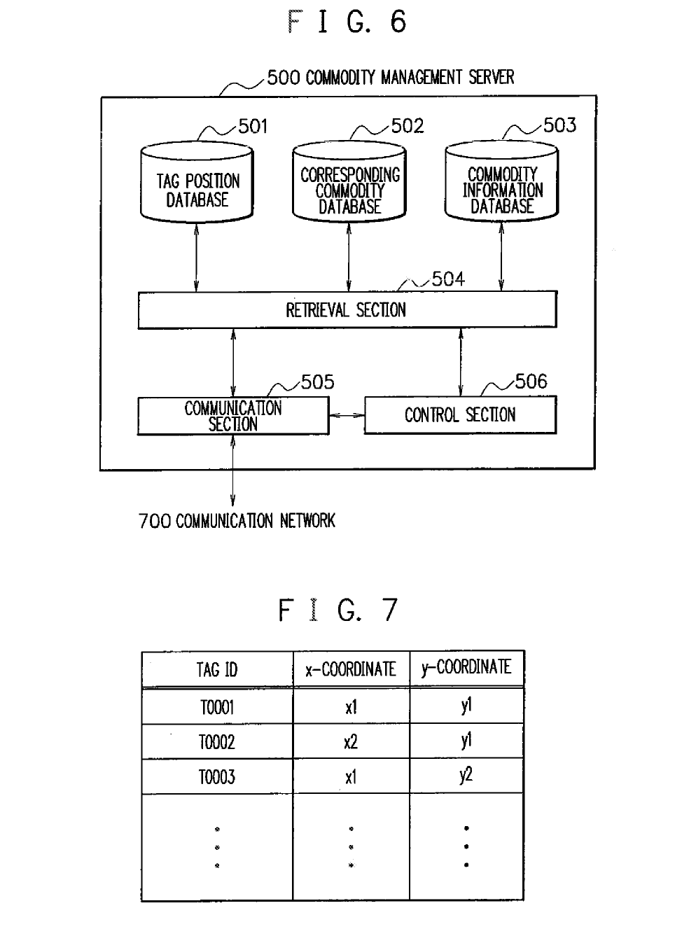

FIG. 6 is a view showing an example of the internal configuration of the commodity management server 500 shown in FIG. 1.

As shown in FIG. 6, the commodity management server 500 shown in FIG. 1 is provided with a tag position database 501, a corresponding commodity database 502, a commodity information database 503, a retrieval section 504, a communication section 505, and a control section 506.

The tag position database 501 stores the tag identification information and the position coordinates in the space coordinate system so as to correspond mutually.

FIG. 7 is a view showing an example of the correspondence stored in the tag position database 501 shown in FIG. 6.

As shown in FIG. 7, in the tag position database 501 shown in FIG. 6, a tag ID serving as tag identification information, an x-coordinate and a y-coordinate are stored so as to correspond mutually. For example, as shown in FIG. 7, a tag ID “T0001”, an x-coordinate “x1” and a y-coordinate “y1” are stored so as to correspond mutually. This indicates that the IC tag 102 in which the tag ID “T0001” has been written is disposed at the position indicated by the coordinates (x1, y1) on the tag array board 100. Furthermore, a tag ID “T0002”, an x-coordinate “x2” and a y-coordinate “y2” are stored so as to correspond mutually. This indicates that the IC tag 102 in which the tag ID “T0002” has been written is disposed at the position indicated by the coordinates (x2, y2) on the tag array board 100. Moreover, a tag ID “T0003”, an x-coordinate “x3” and a y-coordinate “y3” are stored so as to correspond mutually. This indicates that the IC tag 102 in which the tag ID “T0003” has been written is disposed at the position indicated by the coordinates (x3, y3) on the tag array board 100.

The corresponding commodity database 502 stores the tag identification information and commodity identification information so as to correspond mutually.

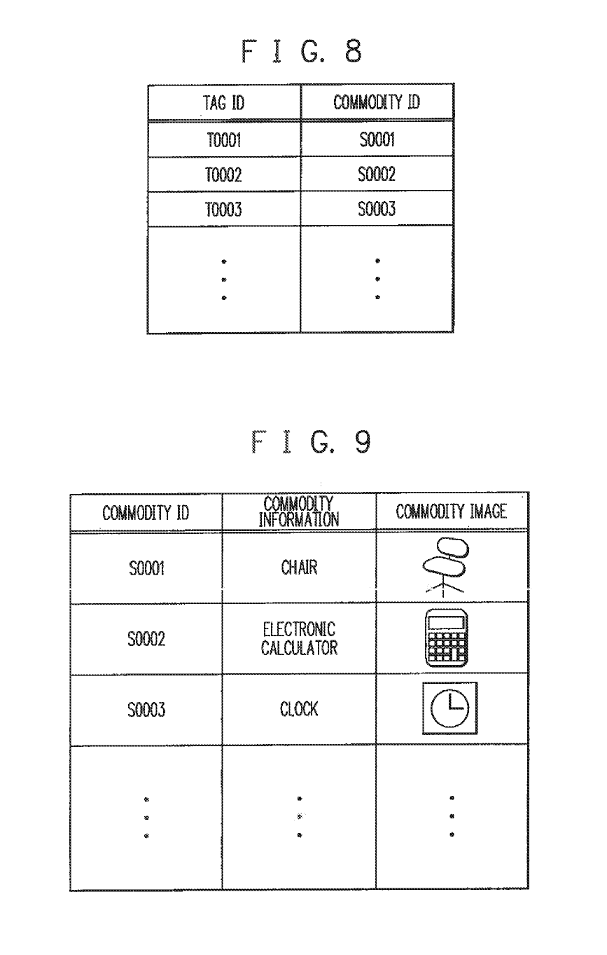

FIG. 8 is a view showing an example of the correspondence stored in the corresponding commodity database 502 shown in FIG. 6.

As shown in FIG. 8, in the corresponding commodity database 502 shown in FIG. 6, a tag ID serving as tag identification information and an commodity ID serving as commodity identification information are stored so as to correspond mutually. For example, as shown in FIG. 8, a tag ID “T0001” and a commodity ID “S0001” are stored so as to correspond mutually. This indicates that the commodity ID of the commodity image displayed at the position where the IC tag 102 having tag ID “T0001” is disposed is “S0001”. Furthermore, a tag ID “T0002” and a commodity ID “S0002” are stored so as to correspond mutually. This indicates that the commodity ID of the commodity image displayed at the position where the IC tag 102 having tag ID “T0002” is disposed is“S0002”. Moreover, a tag ID “T0003” and a commodity ID “S0003” are stored so as to correspond mutually. This indicates that the commodity ID of the commodity image displayed at the position where the IC tag 102 having tag ID “T0003” is disposed is “S0003”.

The commodity information database 503 stores the commodity identification information, the commodity information and the commodity image so as to correspond mutually.

FIG. 9 is a view showing an example of the correspondence stored in the commodity information database 503 shown in FIG. 6.

As shown in FIG. 9, in the commodity information database 503 shown in FIG. 6, a commodity ID, commodity information (for example, a commodity name) indicating a commodity, and a commodity image serving as the image of the commodity are stored so as to correspond mutually. For example, as shown in FIG. 9, a commodity ID “S0001”, commodity information “chair” and the image of the chair are stored so as to correspond mutually. This indicates that the commodity having the commodity ID “S0001” is a “chair” and the image to be displayed to indicate, the chair is the commodity image shown in FIG. 9. Furthermore, a commodity ID “S0002”, commodity information “electronic calculator” and the image of the electronic calculator are stored so as to correspond mutually. This indicates that the commodity having the commodity ID “S0002” is an “electronic calculator” and the image to be displayed to indicate the electronic calculator is the commodity image shown in FIG. 9. Moreover, a commodity ID “S0003”, commodity information “clock” and the image of the clock are stored so as to correspond mutually. This indicates that the commodity having the commodity ID “S0003” is a “clock” and the image to be displayed to indicate the clock is the commodity image shown in FIG. 9.

On the basis of the coordinates included in the coordinate range of the space coordinate system transmitted from the communication terminal 300, the retrieval section 504 retrieves a tag ID serving as tag identification information from the tag position database 501. In addition, on the basis of the retrieved tag ID, the retrieval section 504 retrieves a commodity ID serving as commodity identification information from the corresponding commodity database 502. Furthermore, on the basis of the retrieved commodity ID, the retrieval section 504 retrieves a commodity image from the commodity information database 503. Moreover, the retrieval section 504 outputs the retrieved commodity image to the communication section 505. At this time, the retrieval section 504 outputs the coordinates used for the retrieval to the communication section 505 as display coordinates.

Furthermore, on the basis of the tag ID transmitted from the communication terminal 300, the retrieval section 504 retrieves a commodity ID from the corresponding commodity database 502. Moreover, the retrieval section 504 outputs the retrieved commodity ID to the communication section 505.

The communication section 505 is equipped with an interface function with the communication network 700 and transmits the commodity image and the display coordinates output from the retrieval section 504 to the communication terminal 300. In addition, the communication section 505 transmits the commodity ID output from the retrieval section 504 to the communication terminal 300.

The control section 506 controls the commodity management server 500. On the basis of the retrieval results of the retrieval section 504, the control section 506 performs predetermined processing (for example, commodity purchase processing, transmission processing for transmitting information required for the processing to a server (the purchase management server 600 in the embodiment shown in FIG. 1), etc.).

Correspondence information being different for each communication terminal 300 (user) may be stored in the tag position database 501, the corresponding commodity database 502 and the commodity information database 503. In other words, communication terminal identification information is stored so as to correspond to the above-mentioned correspondence, and in the case that the communication terminal identification information is transmitted from the communication terminal 300, the retrieval section 504 may retrieve the respective information using the communication terminal identification information. Hence, the display of a commodity, etc. being different for each user can be performed. Furthermore, correspondence information being different for each of date and time, time zone, day of the week, season, etc. (hereafter referred to as time or the like) may be stored in the tag position database 501, the corresponding commodity database 502 and the commodity information database 503. In other words, the information on time or the like is stored so as to correspond to the above-mentioned correspondence, and the retrieval section 504 may retrieve the respective information by also using the retrieval time or the like. Hence, the display of a commodity, etc. being different for each time or the like can be performed.

An information processing method according to the first embodiment shown in FIG. 1 will be described below.

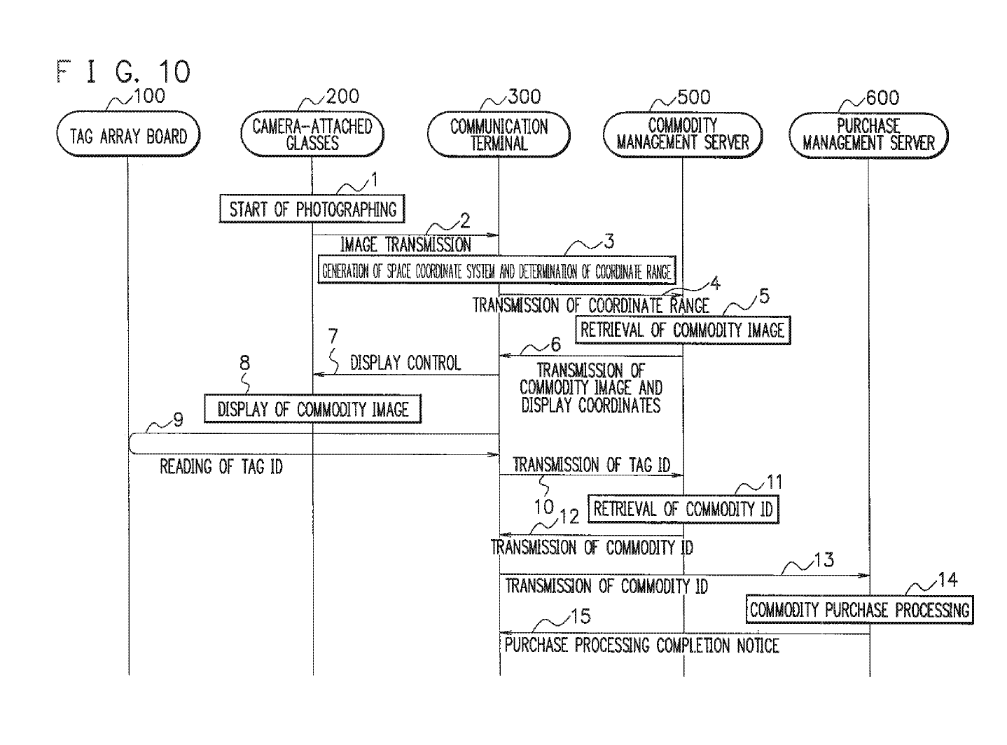

FIG. 10 is a sequence diagram illustrating the information processing method according to the first embodiment shown in FIG. 1.

First, the communication terminal 300 starts a predetermined application; when the photographing section 201 of the camera-attached glasses 200 starts photographing the tag array board 100 at step 1, the communication section 202 transmits the image (first image) being photographed by the photographing section 201to the communication terminal 300 using wireless communication or the like at step 2.

Then, the acquisition section 301 of the communication terminal 300 acquires the transmitted first image. Next, the space coordinate system generation section 302 identifies the markers 101 in the first image and generates a space coordinate system on the basis of the relative positions of the markers 101 in the first image.

A method for generating a space coordinate system will be described below with specific numerical values given as examples.

For example, it is assumed that, in a virtual space serving as a space coordinate system, the coordinates of the virtual space of the tag array board 100 are (xp, yp). FIG. 7 shows the correspondence between each IC tag and the position coordinates of the tag on the coordinates of the tag array board in the virtual space. In addition, as shown in FIG. 5, an IC tag 102 is disposed at the position of xp=210, yp=124.

Furthermore, it is assumed that the size of the tag array board 100 in the virtual space is 300×200. Moreover, the photographing section 201 has the coordinates (xq, yq) of the photographed image (first image) depending on the resolution of a CCD (Charge Coupled Device) or the like. For example, the size of the photographed image (first image) is 600×400. What's more, the display section 203 (display image) has the coordinates (xr, yr) of the display section depending on the resolution of a liquid crystal display or the like. For example, it is assumed that the size of the display image is 600×400. The size of the photographed image (first image) is not necessarily the same as the size of the display image.

The correspondence (for example, equations for mutual conversion) among the coordinates of the virtual space, the coordinates of the photographed image (first image) and the coordinates of the display section is stored in the storage section (not shown) of the communication terminal 300. The correspondence between the coordinates of the photographed image (first image) and the coordinates of the virtual space is performed each time an image is photographed. Furthermore, the correspondence (for example, conversion equations) between the coordinates of the photographed image (first image) and the coordinates of the display section is preliminarily stored in the storage section. In the case that the above-mentioned optical see-through type camera-attached glasses 200 is used, the space coordinate system generation section 302 performs correspondence with respect to size so that the actual scene and the photographed image (first image) acquired by photographing the scene have an overlapped relationship. When the space coordinate system generation section 302 performs this correspondence, not only size but also rotation, offsets in the X and Y directions, trapezoid correction, etc. may be included. A case in which the conversion equations between the coordinates (xq, yq) of the photographed image (first image) and the coordinates (xp, yp) of the virtual space are expressed by xp=a×xq+b, yp=c×yq+d (a, b, c and d are variables obtained each time an image is photographed) is herein described.

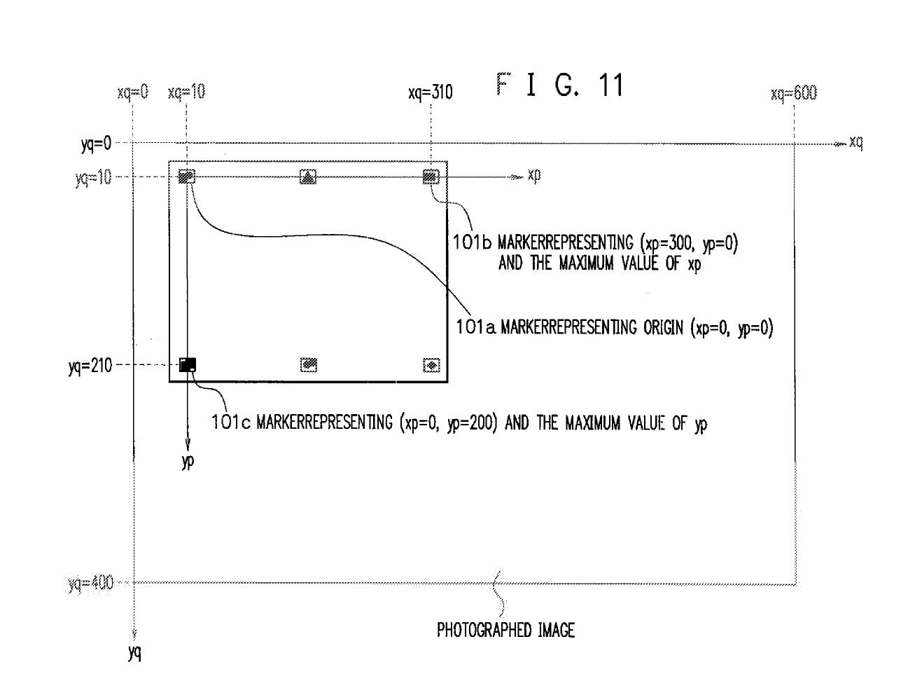

The space coordinate system generation section 302 recognizes the positions and shapes of the markers 101 included in the photographed image (first image) by performing pattern matching or the like. A case in which the image shown in FIG. 11 is acquired as the photographed image (first image) is described as an example. The space coordinate system generation section 302 recognizes that the marker 101a representing the origin (xp=0, yp=0) is located at (xq=10, yq=10); that the marker 101b meaning (xp=300, yp=0) and the maximum value of xp is located at (xq=310, yq=10); and that the marker 101c meaning (xp=0, yp=200) and the maximum value of yp is located at (xq=10, yq=210). The meaning of each marker 101 may be preliminarily made to correspond to the image shape of the marker 101, or the image shape of the marker 101 may be provided with a decodable pattern. At this time, the variables a, b, c and d in the conversion equations are calculated as a=1, b=−10, c=1 and d=−10 by simultaneous equations. In other words, in this case, the relationship between the coordinates (xq, yq) of the photographed image (first image) and the coordinates (xp, yp) of the virtual space is expressed by conversion equations: xp=xq−10, yp=yq−10 (or xq=xp+10, yq=yp+10 (Example 1).

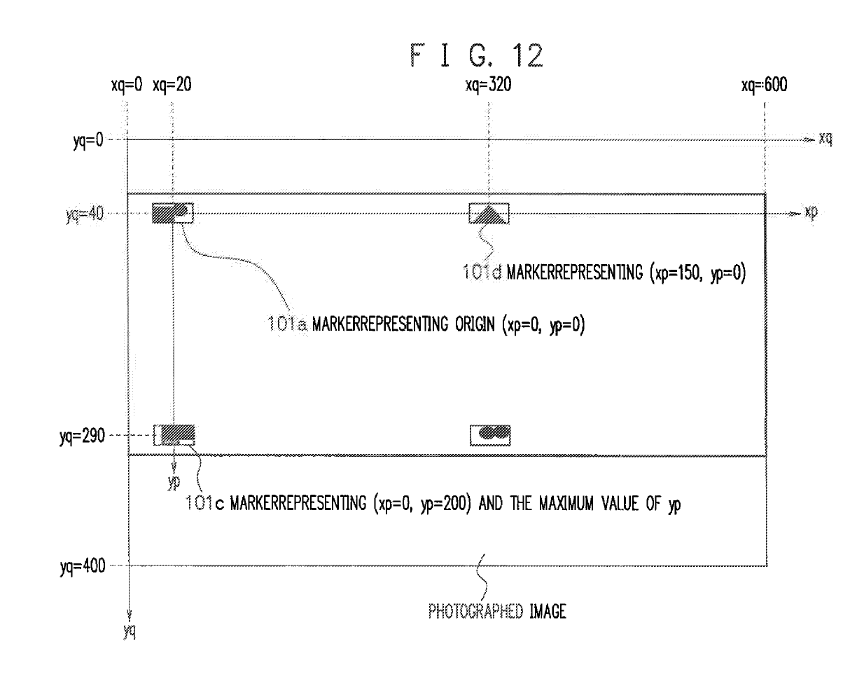

Furthermore, a case in which the image shown in FIG. 12 is acquired as the photographed image (first image) is described as another example. The space coordinate system generation section 302 recognizes that the marker 101a representing the origin (xp=0, yp=0) is located at (xq=20, yq=40); that the marker 101d meaning (xp=150, yp=0) is located at (xq=320, yq=40); and that marker 101e meaning (xp=0, yp=200) and the maximum value of yp is located at (xq=20, yq=290). At this time, the variables a, b, c and d in the conversion equations are calculated as a=0.5, b=−10, c=0.8 and d=−32 by simultaneous equations. In other words, in this case, the relationship between the coordinates (xq, yq) of the photographed image (first image) and the coordinates (xp, yp) of the virtual space is expressed by conversion equations: xp=0.5xq−10, yp=0.8yq−32 (Example 2).

Next, the space coordinate system generation section 302 transmits the conversion equations to the coordinate range determination section 303, and the coordinate range determination section 303 determines the coordinate range of the photographed image (first image) at step 3.

More specifically, on the basis of the conversion equations, the coordinate range of the photographed image (first image) and the coordinate range of the tag array board 100, the coordinate range determination section 303 recognizes the range (how much of which portion of the tag array board 100 is photographed) of the tag array board 100 in the photographed image (first image). The coordinate range determination section 303 then converts the recognized range into the range in the coordinates of the tag array board 100 in the virtual space. In Example 1 described above, since it can be recognized that the whole of the tag array board 100 has been photographed, the coordinate range determination section 303 makes conversion such that the range of xp=0 to 300, yp=0 to 200 has been photographed. Furthermore, in Example 2 described above, since the tag array board 100 is not photographed up to the place corresponding to xq=600 in the xp direction, the coordinate range determination section makes conversion such that the range of xp=0 to 290 (=0.5×600−10), yp=0 to 200 has been photographed.

Then, at step 4, the communication section 304 transmits the determined range in the space coordinate system, that is, the coordinate range in the photographed virtual space, to the commodity management server 500 via the wireless base station 400 and the communication network 700.

When the communication section 505 of the commodity management server 500 receives the coordinate range transmitted from the communication terminal 300, the retrieval section 504 retrieves a tag ID included in the coordinate range from the tag position database 501 on the basis of the coordinates included in the coordinate range. Next, the retrieval section 504 retrieves a commodity ID from the corresponding commodity database 502 on the basis of the retrieved tag ID. Then, at step 5, the retrieval section 504 retrieves a commodity image from the commodity information database 503 on the basis of the retrieved commodity ID.

After the retrieval of the commodity image, at step 6, the communication section 505 transmits the retrieved commodity image and the coordinates (display coordinates) used for the above-mentioned retrieval to the communication terminal 300 via the communication network 700 and the wireless base station 400.

When the communication section 304 of the communication terminal 300 receives the commodity image and the display coordinates transmitted from the commodity management server 500, the display control section 305 performs control to display the received commodity image on the display section 203 of the camera-attached glasses 200 at step 7. At this time, even if the same display coordinates are used, if there is a difference in the relationship between the coordinates (xq, yq) of the photographed image (first image) and the coordinates (xp, yp) of the virtual space or in the relationship between the coordinates (xq, yq) of the photographed image (first image) and the coordinates (xr, yr) of the display section, the display position on the display section 203 of the camera-attached glasses 200 becomes different. For this reason, the display control section 305 performs control to convert the display coordinates in the virtual space of the received commodity into display coordinates according to the relationship between the coordinates (xq, yq) of the photographed image (first image) and the coordinates (xp, yp) of the virtual space or the relationship between the coordinates (xq, yq) of the photographed image (first image) and the coordinates (xr, yr) of the display section, and also performs control to display a display image on the display section 203. For example, after receiving xp=210, yp=124 as the display coordinates, the display control section 305 calculates as follows: xq=210+10=220, yq=124+10=134, by using the conversion equations in Example 1 described above. When it is assumed that the relationship between the coordinates (xq, yq) of the photographed image (first image) and the coordinates (xr, yr) of the display section is xr=xq, yr=yq, the display control section 305 converts the position xq=220, yq=134 into the position xr=220, yr=134 in the coordinates on the display image having a size of 600×400 and then performs display control. When identifying the marker 101 from the photographed image (first image), the space coordinate system generation section 302 may convert the photographed image (first image) into the size of the display image, recognize the position and the size of the tag array board 100 in the display image and perform processing.

The position after this conversion is the position in which the IC tag 102 of the tag array board 100 is disposed on the image viewed by the user wearing the camera-attached glasses 200. With this control, at step 8, the display section 203 of the camera-attached glasses 200 displays the commodity image at the position designated by the display control section 305.

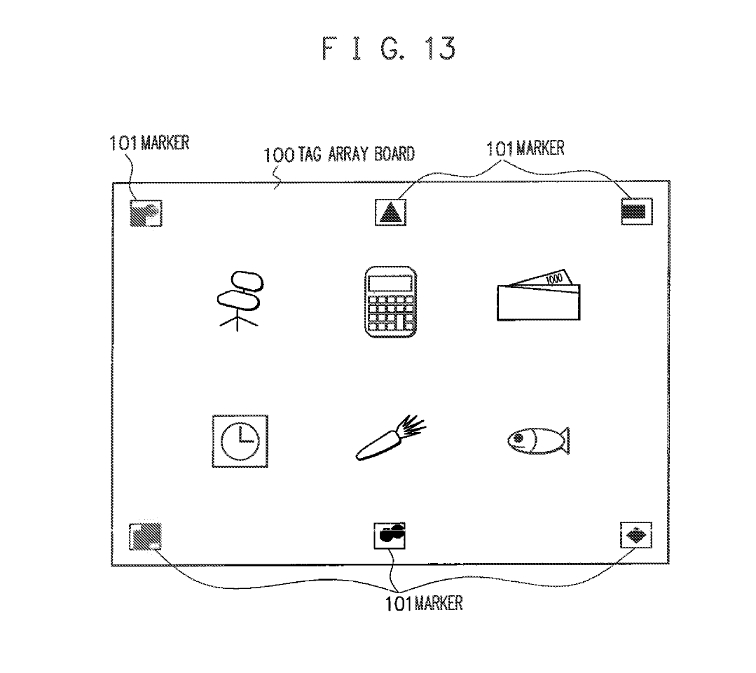

FIG. 13 is a view showing an example of commodity images viewed by the user wearing the camera-attached glasses 200.

As shown in FIG. 13, the commodity images of a chair, an electronic calculator, a wallet, a clock, a vegetable and a fish are displayed at the designated positions of the display section 203, and the respective commodity images are seen as images overlapped with the tag array board 100. At this time, the respective commodity images are images viewed by the user wearing the camera-attached glasses 200 and displayed at the positions in which the IC tags 102 of the tag array board 100 are disposed.

Furthermore, as described above, images being different for each user can be displayed by using the communication terminal identification information. For example, commodities, all of which are foods, may be stored in the communication terminal identification information of another user.

After the processing of step 8, furthermore, at step 2, the communication section 202 performs the processing of transmitting the image being photographed by the photographing section 20l to the communication terminal 300. In other words, the processing from image photographing to image display is repeated at predetermined time intervals.

Moreover, after this image display was performed, according to the images that can be seen by the user, the user brings the communication terminal 300 close to the position on the tag array board 100 in which a desired commodity image has been displayed, and at step 9, the information reading section 306 of the communication terminal 300 reads the tag ID written in the IC tag 102 disposed at the position. Then, at step 10, the read tag ID is transmitted from the communication section 304 to the commodity management server 500 via the wireless base station 400 and the communication network 700.

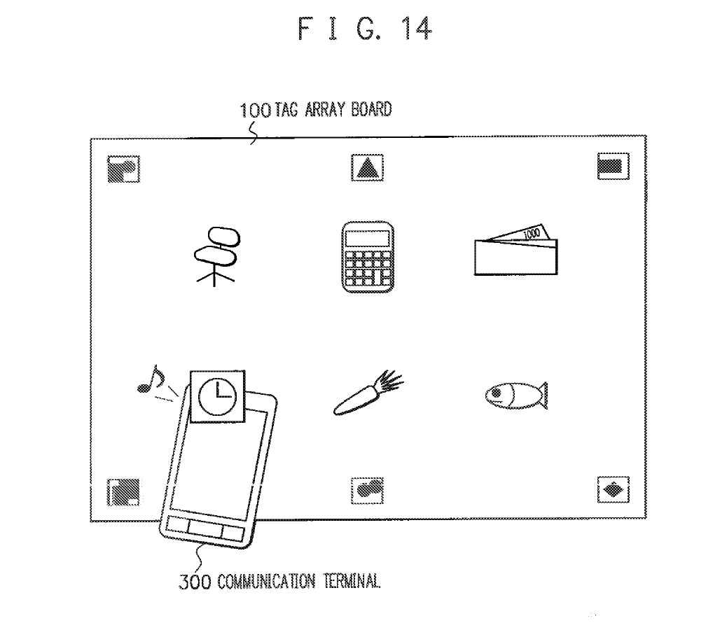

FIG. 14 is a view showing an example of a screen seen by the user when the user brings the communication terminal 300 close to the position on the tag array board 100 in which the desired commodity image has been displayed, according to the images that can be seen.

As shown in FIG. 14, when the user brings the communication terminal 300 close to the position (the position in which the clock is displayed) on the tag array board 100 in which the desired commodity image has been displayed, according to the images that can be seen by the user, the information reading section 306 of the communication terminal 300 reads the tag ID written in the IC tag 102 disposed at the position.

When the communication section 505 of the commodity management server 500 receives the tag ID transmitted from the communication terminal 300, the retrieval section 504 retrieves the commodity ID from the corresponding commodity database 502 on the basis of the tag ID at step 11. The retrieved commodity ID is transmitted from the communication section 505 to the communication terminal 300 via the communication network 700 and the wireless base station 400 at step 12. At this time, a purchase operation screen including commodity information (to which not only the name of the commodity, but also commodity explanation information, such as the price and size thereof, may be added) stored in the corresponding commodity information database 503 by using the retrieved commodity ID. Then, when operation for purchasing the commodity having this commodity ID is performed by the user at the communication terminal 300 having received the commodity ID transmitted from the commodity management server 500, the commodity ID is transmitted from the communication section 304 to the purchase management server 600 via the wireless base station 400 and the communication network 700 at step 13.

After receiving the commodity ID, the purchase management server 600 performs purchase processing for the commodity having the commodity ID at step 14. After the purchase processing is completed, the purchase management server 600 transmits a purchase processing completion notice indicating that the purchase processing has been completed to the communication terminal 300 via the communication network 700 and the wireless base station 400 at step 15. After receiving this notice, the communication terminal 300 displays the notice.

In the above-mentioned example, a case in which the positions in which the IC tags 102 on the tag array board 100 are disposed and the positions in which the commodity images are displayed (the positions in which the commodity images can be seen by the user wearing the camera-attached glasses 200) are the same is described as an example; however, these positions may be mutually different.

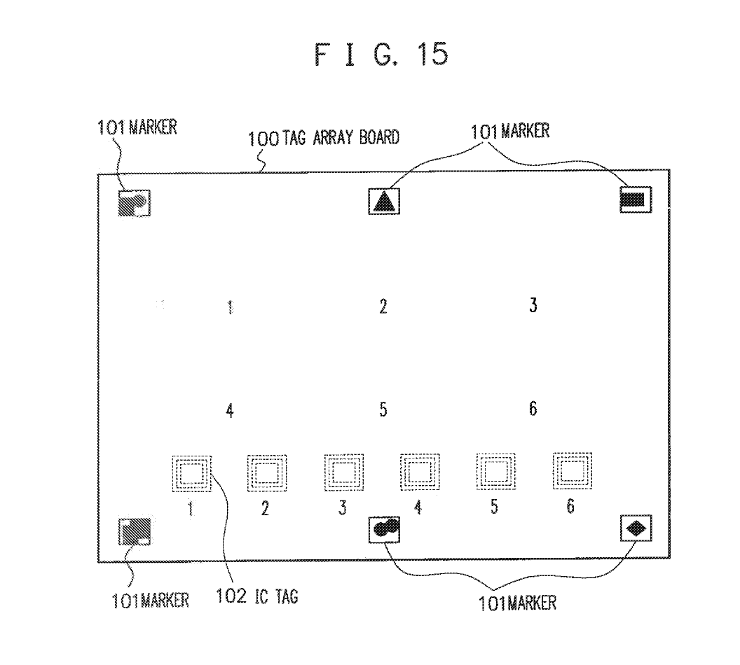

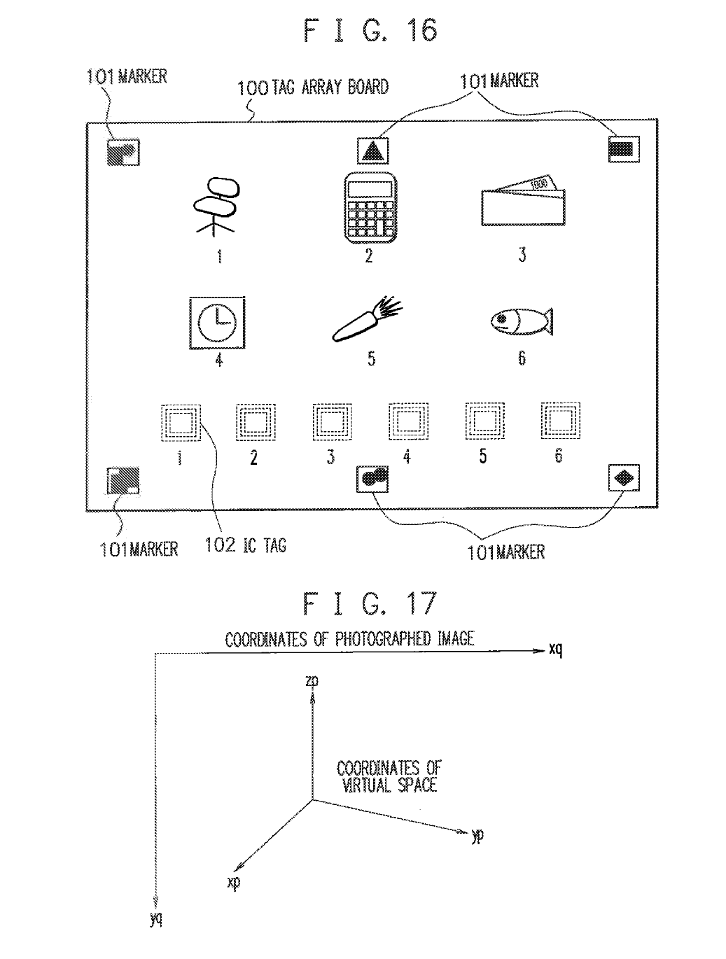

FIG. 15 is a view showing an example of the arrangement of the IC tags 102 in which the positions in which the IC tags 102 on the tag array board 100 are disposed and the positions in which the commodity images are displayed (the positions in which the commodity images can be seen by the user wearing the camera-attached glasses 200) are mutually different. Furthermore, FIG. 16 is a view showing an example of images that can be seen from the user wearing the camera-attached glasses 200in the case that the IC tags are disposed as shown in FIG. 15 and when the commodity images are displayed.

As shown in FIG. 15, the IC tags 102 are arranged in sequence on the lower side of the tag array board 100 and numbers are indicated at their respective positions. Furthermore, there above and at the positions in which numbers are indicated, no IC tags 102 are disposed. At this time, the coordinates made to correspond to a tag ID by the tag position database 501 of the commodity management server 500 are not the coordinates in which the IC tag 102 is disposed, but the coordinates of the position indicating the commodity image corresponding to the tag ID. Hence, when the commodity images are displayed, as shown in FIG. 16, the commodity images are not displayed at the positions in which the IC tags 102 are disposed but displayed at positions above the positions in which the same numbers as the numbers displayed at the positions in which the IC tags 102 are disposed.

Although a case in which the coordinate system generated by the space coordinate system generation section 302 is a two-dimensional coordinate system is described as an example, the coordinate system may be a three-dimensional coordinate system. In the case that the coordinate system is made three-dimensional, even in the case that the photographing section 201 obliquely photographs the tag array board 100, natural displaying can be achieved, whereby it is not necessary to perform photographing right in front of the board. Furthermore, the commodity image to be displayed may be a three-dimensional object image instead of a two-dimensional image. In the case that the coordinate system generated by the space coordinate system generation section 302 is three-dimensional, the coordinate system will be described below.

FIG. 17 is a view showing an example of the conversion between the coordinates (xq, yq) of the photographed image (first image) and the coordinates (xp, yp, zp) of the virtual space serving as a space coordinate system in the case that the coordinate system generated by the space coordinate system generation section 302 shown in FIG. 4 is three-dimensional.

As shown in FIG. 17, the relationship between the coordinates (xq, yq) of the photographed image (first image) and the coordinates (xp, yp, zp) of the virtual space serving as a three-dimensional coordinate system is the relationship expressed by (Equation 1) and (Equation 2).

xq=f(xp, yp, zp) (Equation 1)

yq=g(xp, yp, zp) (Equation 2)

wherein f and g are conversion functions generated by performing the image recognition of the marker 101 and can change with time. Hence, the position at the coordinates of the virtual space in which the IC tags 102 are disposed can be made to correspond to the coordinates of the photographed image (first image) and the display coordinates.

Furthermore, as in the case of the two-dimensional coordinate system, on the basis of the positions, shapes, mutual distances and relative positions (including angles) of the identified markers 101, the space coordinate system generation section 302 may determine an x-coordinate axis, a y-coordinate axis and a z-coordinate axis, and may generate a three-dimensional AR display space coordinate system from the respective coordinate axes.

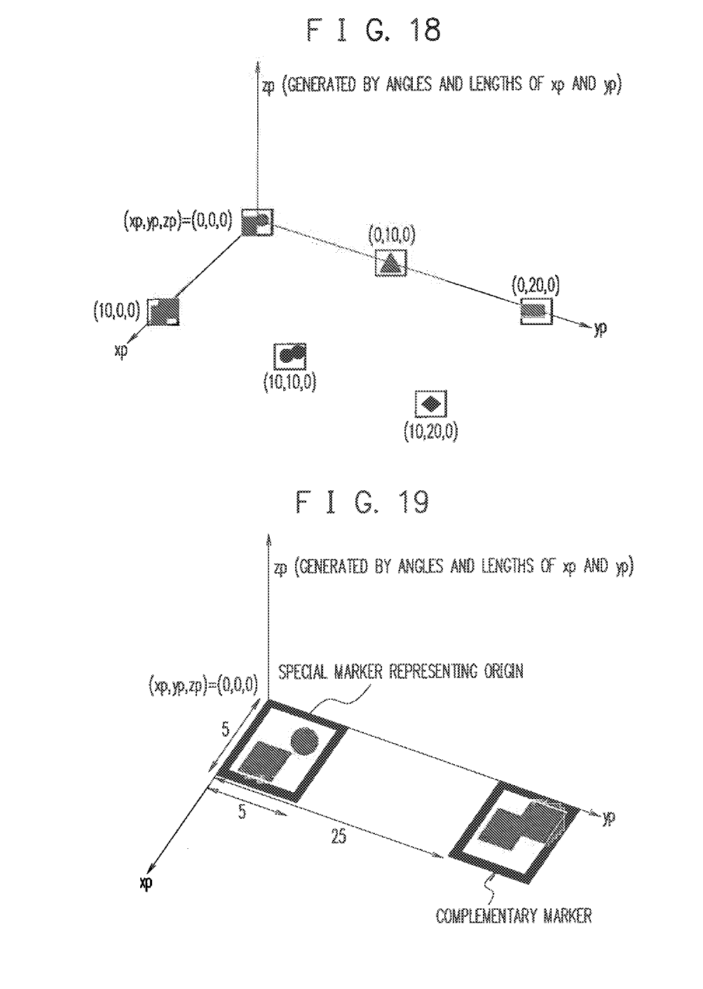

FIG. 18 is a view showing an example in which the space coordinate system generation section 302 shown in FIG. 4 generates the coordinates of the virtual space on the basis of the mutual distances and relative positions (including angles) of the markers 101.

As shown in FIG. 18, on the basis of the distances and relative positions (including angles) of the mutually adjacent markers 101, the space coordinate system generation section 302 may generate the x-coordinate axis, the y-coordinate axis and the z-coordinate axis. Herein, a zp-coordinate axis is generated on the basis of the mutual angles and lengths (unit coordinates) of the xp-coordinate axis and the yp-coordinate axis.

FIG. 19 is a view showing an example in which the space coordinate system generation section 302 shown in FIG. 4 generates the coordinates of the virtual space on the basis of the shapes of the markers 101.

As shown in FIG. 19, a special marker representing the origin of the coordinate axes is set, and the space coordinate system generation section 302 may generate the xp-coordinate axis and the yp-coordinate axis on the basis of the length of one side of the marker, the angle formed of two sides of the marker and the relative position to another complementary marker, and may generate a zp-coordinate axis on the basis of the mutual angles and lengths (unit coordinates) of the xp-coordinate axis and the yp-coordinate axis.

Moreover, the space coordinate system generation section 302 may extract the characteristic amounts of a commodity image, recognize an object from the image, and generate the coordinates of the virtual space on the basis of predetermined information.

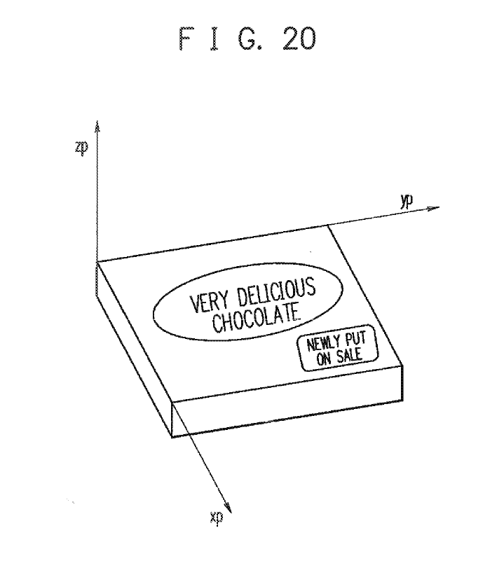

FIG. 20 is a view showing an example in which the space coordinate system generation section 302 generates the coordinates of the virtual space on the basis of the commodity image.

As shown in FIG. 20, the space coordinate system generation section 302 extracts the characteristic amounts from the commodity image of a chocolate, recognizes an object, and recognizes its shape. Then, the space coordinate system generation section may generate the coordinates of the virtual space on the basis of the direction (angle), length, etc. of the recognized shape and predetermined information.

### Second Embodiment

In the first embodiment, a case in which the main section for generating the space coordinate system from the image photographed by the camera-attached glasses 200 is the communication terminal 300 is described as an example; however, this processing may be performed by a commodity management server.

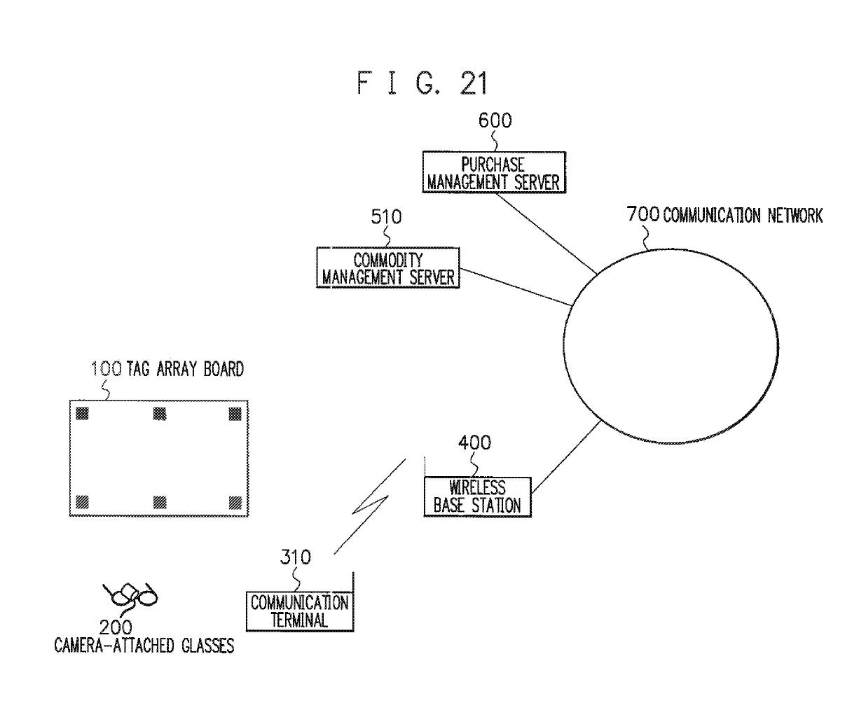

FIG. 21 is a view showing a second embodiment of the information processing system of the present invention.

As shown in FIG. 21, the information processing system according to this embodiment is provided with a tag array board 100, camera-attached glasses 200, a communication terminal 310, a wireless base station 400, a commodity management server 510, and a purchase management server 600. Furthermore, the wireless base station 400, the commodity management server 510 and the purchase management server 600 are connected mutually via a communication network 700. The components, to which the same reference numerals as those in the first embodiment shown in FIG. 1 are given, have the same functions and are riot described herein.

The communication terminal 310 acquires a first image photographed by a camera-attached glasses 200. In addition, the communication terminal 310 transmits the acquired first image to the commodity management server 510 via the wireless base station 400 and the communication network 700. Furthermore, the communication terminal 310 displays a second image transmitted from the commodity management server 510 at the position based on the display coordinates of the camera-attached glasses 200. What's more, the communication terminal 310 has a tag reader function and reads tag identification information from IC tags 102 disposed on the tag array board 100. Moreover, the communication terminal 310 transmits the read tag identification information to the commodity management server 510 via the wireless base station 400 and the communication network 700.

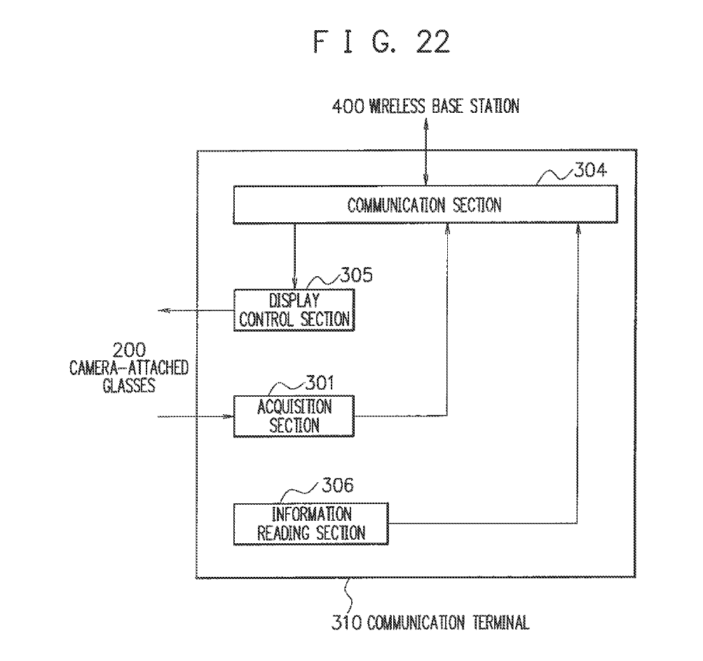

FIG. 22 is a view showing an example of the internal configuration of the communication terminal 310 shown in FIG. 21.

As shown in FIG. 22, the communication terminal 310 shown in FIG. 21 is provided with an acquisition section 301, a communication section 304, a display control section 305, and an information reading section 306. As shown in FIG. 21, the communication terminal 310 is not provided with the space coordinate system generation section 302 and the coordinate range determination section 303 shown in FIG. 4. In other words, the first image acquired by the acquisition section 301 from the camera-attached glasses 200 is directly transmitted from the communication section 304 to the commodity management server 510 via the wireless base station 400 and the communication network 700. The other functions are the same as those shown in FIG. 4.

The commodity management server 510 is a server for transmitting the second image corresponding to the first image transmitted from the communication terminal 310 and the display coordinates for displaying the second image to the communication terminal 310. At this time, in the case that communication terminal identification information is transmitted together with the first image from the communication terminal 310 to the commodity management server 510, the commodity management server may retrieve the second image corresponding to the first image and the communication terminal identification information. Furthermore, the commodity management server 510 performs predetermined processing on the basis of the tag identification information transmitted from the communication terminal 310.

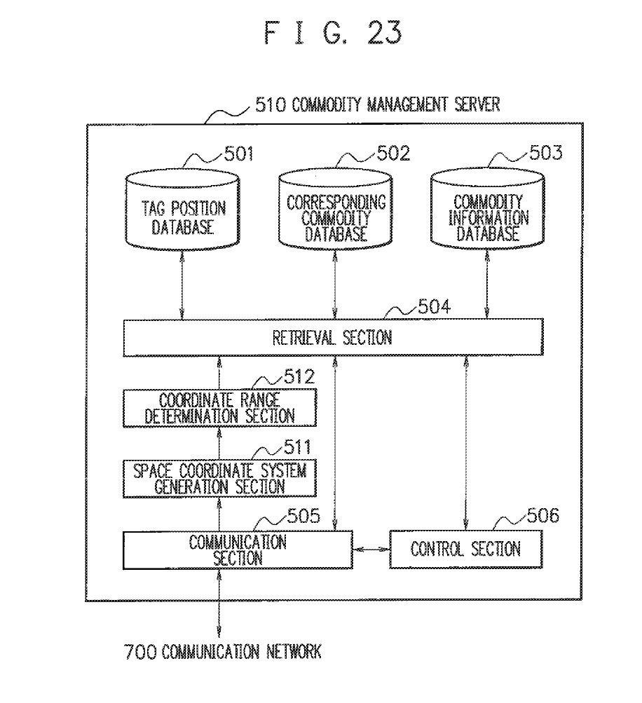

FIG. 23 is a view showing an example of the internal configuration of the commodity management server 510 shown in FIG. 21.

As shown in FIG. 23, the commodity management server 510 shown in FIG. 21 is provided with a tag position database 501, a corresponding commodity database 502, a commodity information database 503, a retrieval section 504, a communication section 505, a control section 506, a space coordinate system generation section 511 and a coordinate range determination section 512. As shown in FIG. 23, in the commodity management server 510, the space coordinate system generation section 511 and the coordinate range determination section 512 are added to the components provided for the commodity management server 500 shown in FIG. 6. The other functions are the same as those shown in FIG. 6.

The space coordinate system generation section 511 identifies the markers 101 serving as predetermined identification images in the first image transmitted from the communication terminal 310. In addition, the space coordinate system generation section 511 generates a space coordinate system serving as the coordinate system of the tag array board 100 in a virtual space on the basis of the relative positions of the markers 101 in the first image. The method for generating this space coordinate system may be the same as the generation method in the space coordinate system generation section 302 shown in FIG. 4. Furthermore, the space coordinate system generation section 511 outputs the generated space coordinate system to the coordinate range determination section 512.

The coordinate range determination section 512 determines the coordinate range of the space coordinate system output from the space coordinate system generation section 511. In other words, the coordinate range determination section 512 determines the range of the first image (photographed by the camera-attached glasses 200) transmitted from the communication terminal 310 in the space coordinate system that can be generated by the whole of the tag array board 100. The method for determining this coordinate range may be the same as the determination method in the coordinate range determination section 303 shown in FIG. 4. Furthermore, the coordinate range determination section 512 outputs the space coordinate system and the coordinate range to the retrieval section 504.

An information processing method according to the second embodiment shown in FIG. 21 will be described below.

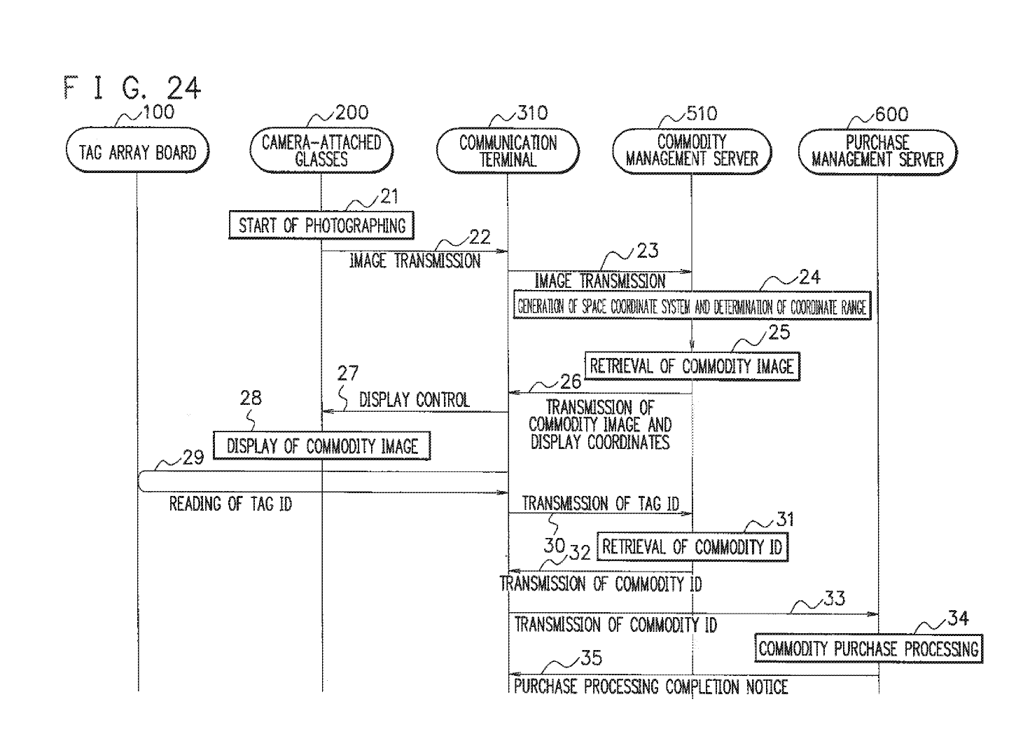

FIG. 24 is a sequence diagram illustrating the information processing method according to the second embodiment shown in FIG. 21.

First, the communication terminal 310 starts a predetermined application; when the photographing section 201 of the camera-attached glasses 200 starts photographing the tag array board 100 at step 21, the communication section 202 transmits the image (first image) being photographed by the photographing section 201 to the communication terminal 310 using wireless communication or the like at step 22.

Then, the acquisition section 301 of the communication terminal 310 acquires the transmitted first image. Next, at step 23, the communication section 304 transmits the first image to the commodity management server 510 via the wireless base station 400 and the communication network 700.

When the communication section 505 of the commodity management server 510 receives the first image transmitted from the communication terminal 310, at step 24, the space coordinate system generation section 511 identifies the markers 101 in the first image and generates a space coordinate system on the basis of the relative positions of the markers 101 in the first image. Furthermore, the coordinate range determination section 512 determines the coordinate range of the first image.

Then, the retrieval section 504 retrieves a tag ID from the tag position database 501 on the basis of the coordinates included in the coordinate range of the space coordinate system. Next, the retrieval section 504 retrieves a commodity ID from the corresponding commodity database 502 on the basis of the retrieved tag ID. Then, at step 25, the retrieval section 504 retrieves a commodity image from the commodity information database 503 on the basis of the retrieved commodity ID.

Furthermore, on the basis of the determined coordinate range, the coordinates (display coordinates) used for the above-mentioned retrieval are converted into the display coordinates on the screen displayed by the camera-attached glasses 200. The main section of this conversion processing may be the retrieval section 504, may be the coordinate range determination section 512, or may be the communication section 505. The reason for this conversion is the same as that for the conversion of the coordinates by the communication terminal 300 in the first embodiment.

After the retrieval of the commodity image, at step 26, the communication section 505 transmits the retrieved commodity image and the converted display coordinates to the communication terminal 310 via the communication network 700 and the wireless base station 400.

When the communication section 304 of the communication terminal 310 receives the commodity image and the display coordinates transmitted from the commodity management server 510, the display control section 305 performs control to display the received commodity image on the display coordinates of the camera-attached glasses 200 at step 27. With this control, at step 28, the display section 203 of the camera-attached glasses 200 displays the commodity image at the position designated by the display control section 305.

After the processing of step 28, furthermore, at step 22, the communication section 202 performs the processing of transmitting the image being photographed by the photographing section 201 to the communication terminal 310. In other words, the processing from image photographing to image display is repeated at predetermined time intervals.

In addition, as in the case of the first embodiment, images being different for each user can be displayed by using the communication terminal identification information.

After this display was performed, according to the images that can be seen by the user, the user brings the communication terminal 310 close to the position on the tag array board 100 in which a desired commodity image has been displayed, and at step 29, the information reading section 306 of the communication terminal 310 reads the tag ID written in the IC tag 102 disposed at the position. Then, at step 30, the read tag ID is transmitted from the communication section 304 to the commodity management server 510 via the wireless base station 400 and the communication network 700 from the communication section 304.

When the communication section 505 of the commodity management server 510 receives the tag ID transmitted from the communication terminal 310, the retrieval section 504 retrieves the commodity ID from the corresponding commodity database 502 on the basis of the tag ID at step 31. The retrieved commodity ID is transmitted from the communication section 505 to the communication terminal 310 via the communication network 700 and the wireless base station 400 at step 32. Then, when operation for purchasing the commodity having this commodity ID is performed by the user at the communication terminal 310 having received the commodity ID transmitted from the commodity management server 510, the commodity ID is transmitted from the communication section 304 to the purchase management server 600 via the wireless base station 400 and the communication network 700 at step 33.

After receiving the commodity ID, the purchase management server 600 performs purchase processing for the commodity having the commodity ID at step 34. After the purchase processing is completed, the purchase management server 600 transmits a purchase processing completion notice indicating that the purchase processing has been completed to the communication terminal 310 via the communication network 700 and the wireless base station 400 at step 35. After receiving this notice, the communication terminal 310 displays the notice.

The display, the coordinates and the structures of the databases in the second embodiment are similar to those described in the first embodiment. These databases may be physically separated or may be integrated into one or may be combined as predetermined. In other words, in these databases, in the case that the tag identification information and the coordinates are made to correspond mutually, that the tag identification information and the commodities or service and object identification information indicating processing functions are made to correspond mutually, and that the object identification information and object images (for example, the commodity images shown in FIG. 9) are made to correspond mutually, the number of the database configurations may be one or may be plural.

In addition to the display of images being different for each user as described above, correspondence and display may be performed for not only commodities but also service and processing functions. An example of these will be described below.

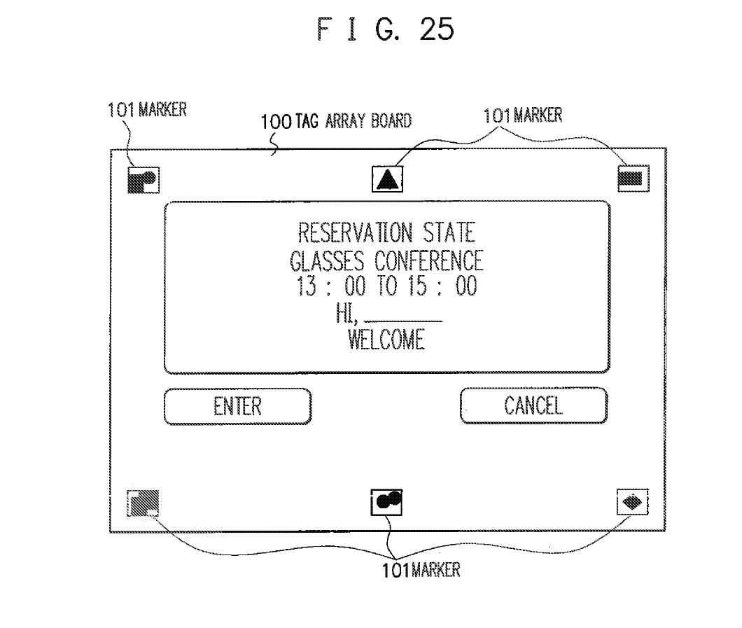

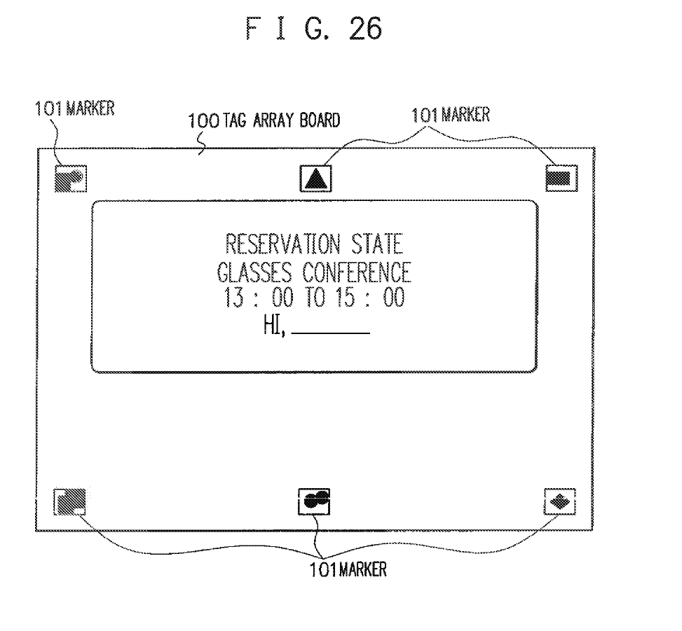

FIG. 25 is an example of an image that can be seen when a user, who has reserved a conference room for a glasses conference, wears the camera-attached glasses 200 and views the tag array board 100. Moreover, FIG. 26 is an example of an image that can be seen when a user, other than the user who has reserved the conference room for the glasses conference, wears the camera-attached glasses 200 and views the tag array board 100.

The display section 203 displays different images between a case in which a user whose communication terminal identification information has preliminarily been registered (stored) in the commodity management server 500 uses his communication terminal 300 and a case in which the other user uses his communication terminal 300. Hence, the image that can be seen by wearing the camera-attached glasses 200 is different depending on the user of the communication terminal. Furthermore, in the case that different processing is made to correspond to a tag ID depending on the user, when the reading of the tag ID was performed, different processing can be performed depending on the user. As shown in FIG. 25, in the case that the user, who has reserved the conference room for the glasses conference, wears the camera-attached glasses 200 and displays an image on the display section 203 using his communication terminal 300, the display for selection of “Enter” or “Cancel” appears. On the other hand, as shown in FIG. 26, in the case that the user, other than the user who has reserved the conference room for the glasses conference, wears the camera-attached glasses 200 and displays an image on the display section 203 using his communication terminal 300, the display for selection of “Enter” or “Cancel” does not appear. Only in the case that the display section 203 performs this display and the user who has reserved the conference room for the glasses conference performed the reading of the tag ID, the processing for “Enter” or “Cancel” is executed, whereby only the user who has reserved the conference room for the glasses conference can select “Enter” or “Cancel”.

As described above, in the case that a different image is displayed depending on whether the communication terminal identification information has been registered in the commodity management server 500 and that the correspondence depending on the communication terminal identification information is registered in the commodity management server 500, an image being different for each user of the communication terminal to which the communication terminal identification information has been given can be displayed.

In addition, the above-mentioned communication terminal identification information may be user identification information assigned to each user and unique to each user, instead of identification information unique to each communication terminal.

Moreover, the image to be displayed on the display section 203 may be made different for each tag array board. In this case, storage and processing are performed so as to correspond to tag array board identification information for identifying the tag array board. At this time, the tag array board identification information is included in the markers.

With the above-mentioned configurations and processing, flexible information corresponding to, for example, time or the like and each user can be provided using an information providing medium requiring no power source.

The processing performed by the components respectively provided for the communication terminals 300 and 310 and the commodity management servers 500 and 510 described above may be performed by using logic, circuits respectively formed according to purposes. Furthermore, a computer program (hereafter referred to as the program) in which the contents of the processing have been written as a procedure may be recorded on a recording medium that can be read by each of the communication terminals 300 and 310 and the commodity management servers 500 and 510, and the program recorded on the recording medium may be read by each of the communication terminals 300 and 310 and the commodity management servers 500 and 510 and then executed. The recording medium that can be read by each of the communication terminals 300 and 310 and the commodity management servers 500 and 510 is a movable recording medium, such as a floppy (registered trademark) disk, a magneto-optical disk, a DVD or a CD; or a memory, such as a ROM or a RAM, or an HDD or the like incorporated in each of the communication terminals 300 and 310 and the commodity management servers 500 and 510. The program recorded on the recording medium is read by a CPU (riot shown) provided in each of the communication terminals 300 and 310 and the commodity management servers 500 and 510, and processing similar to that described above is performed under the control of the CPU. The CPU herein operates as a computer for executing the program read from the recording medium on which the program has been recorded.

Although the present invention has been described above referring to the embodiments, the present invention is not limited to the above-mentioned embodiments. The configurations and details of the present invention can be subjected to various modifications understandable by those skilled in the art within the scope of the present invention.

This application is based upon and claims the benefit of priority from Japanese patent application No. 2012-067551, filed on Mar. 23, 2012, the disclosure of which is incorporated herein its entirety by reference.

1. An information processing system comprising:
an information providing medium, on one face of which information storage media in which tag identification information has been written are disposed, and on the face of which predetermined identification images are displayed,
a photographing display apparatus for photographing at least part of the face of the information providing medium on which the information storage media are disposed,
a communication terminal for identifying the identification images in a first image photographed by the photographing display apparatus, for generating a space coordinate system on the basis of the relative positions of the identification images in the first image, and for transmitting the coordinate range of the generated space coordinate system, and
a server for transmitting a second image corresponding to the coordinate range transmitted from the communication terminal and the display coordinates for displaying the second image to the communication terminal, wherein
the communication terminal displays the second image transmitted from the server at the position based on the display coordinates of the photographing display apparatus, reads the tag identification information from the information storage media, and transmits the read tag identification information to the server, and
the server performs predetermined processing on the basis of the tag identification information transmitted from the communication terminal.

2. The information processing system according to claim 1, wherein
the communication terminal transmits user identification information for identifying the communication terminal or the user when transmitting the coordinate range, and
the server transmits the second image corresponding to the coordinate range and the user identification information to the communication terminal.

3. The information processing system according to claim 1, wherein
the server preliminarily stores the coordinates on the space coordinate system and the second image so as to correspond mutually.

4. An information processing system comprising:
an information providing medium, on one face of which information storage media in which tag identification information has been written are disposed, and on the face of which predetermined identification images are displayed,
a photographing display apparatus for photographing at least part of the face of the information providing medium on which the information storage media are disposed,
a communication terminal for acquiring a first image photographed by the photographing display apparatus and for transmitting the acquired first image, and
a server for transmitting a second image corresponding to the first image transmitted from the communication terminal and the display coordinates for displaying the second image to the communication terminal, wherein
the communication terminal displays the second image transmitted from the server at the position based on the display coordinates of the photographing display apparatus, reads the tag identification information from the information storage media, and transmits the read tag identification information to the server, and
the server performs predetermined processing on the basis of the tag identification information transmitted from the communication terminal.

5. The information processing system according to claim 4, wherein
the server identifies the identification images in the first image, generates a space coordinate system in the first image on the basis of the relative positions of the identification images in the first image, and transmits the second image corresponding to the generated space coordinate system to the communication terminal.

6. The information processing system according to claim 5, wherein
the communication terminal transmits user identification information for identifying the communication terminal or the user when transmitting the first image, and
the server transmits the second image corresponding to the coordinate on the space coordinate system and the user identification information to the communication terminal.

7. The information processing system according to claim 5, wherein
the server preliminarily stores the coordinates on the space coordinate system and the second image so as to correspond mutually.

8. The information processing system according to claim 1, wherein
the photographing display apparatus displays the first image and the second image so as to be overlapped.

9. A communication terminal comprising;
an acquisition section for acquiring a first image photographed by the photographing display apparatus connected to the communication terminal,
a space coordinate system generation section for identifying predetermined identification images in the first image acquired by the acquisition section and for generating a space coordinate system on the basis of the relative positions of the identification images in the first image,
a communication section for transmitting the coordinate range on the space coordinate system generated by the space coordinate system generation section to the server connected to the communication terminal,
a display control section, in the case that a second image and display coordinates have been transmitted from the server, for displaying the second image at the position based on the display coordinates of the photographing display apparatus, and
an information reading section for reading tag identification information from information storage media provided externally, wherein
the communication section transmits the tag identification information read by the information reading section to the server.

10. A server comprising:
a database for storing tag identification information and coordinates so as to correspond to each other, for storing the tag identification information and commodities or service and object identification information indicating processing functions so as to correspond mutually, and for storing the object identification information and object images so as to correspond mutually,
a retrieval section for retrieving the tag identification information on the basis of the coordinate range transmitted from the communication terminal connected to the server, for retrieving the object identification information on the basis of the retrieved tag identification information, and for retrieving the object images on the basis of the retrieved object identification information, using the database,
a communication section for transmitting the object images retrieved by the retrieval section and the display coordinates for displaying the object images to the communication terminal, and
a control section for performing predetermined processing on the basis of the tag identification information transmitted from the communication terminal.

11. A server comprising:
a space coordinate system generation section for identifying the predetermined identification images in the first image transmitted from the communication terminal connected to the server, and for generating a space coordinate system in the first image on the basis of the relative positions of the identification images in the first image,
a communication section for transmitting the second image and the display coordinates corresponding to the space coordinate system generated by the space coordinate system generation section, and
a control section for performing predetermined processing on the basis of the tag identification information transmitted from the communication terminal.

12. An information providing medium, on one face of which information storage media in which tag identification information has been written are disposed, and on the face of which predetermined identification images are displayed.

13. An information processing method in an information processing system equipped with an information providing medium, on one face of which information storage media in which tag identification information has been written are disposed, and on the face of which predetermined identification images are displayed, performing the processes of:
photographing at least part of the face of the information providing medium on which the information storage media are disposed, using the photographing display apparatus,
identifying the identification images in a first image photographed by the photographing display apparatus, using the communication terminal,
generating a space coordinate system on the basis of the relative positions of the identification images in the first image, using the communication terminal,
transmitting the coordinate range of the generated space coordinate system to the server, using the communication terminal,
transmitting a second image corresponding to the coordinate range transmitted from the communication terminal and the display coordinates for displaying the second image to the communication terminal, using the server,
displaying the second image transmitted from the server at the position based on the display coordinates of the photographing display apparatus, using the communication terminal,
reading the tag identification information from the information storage media, using the communication terminal,
transmitting the read tag identification information to the server, using the communication terminal, and
performing predetermined processing on the basis of the tag identification information transmitted from the communication terminal, using the server.

14. An information processing method in an information processing system equipped with an information providing medium, on one face of which information storage media in which tag identification information has been written are disposed, and on the face of which predetermined identification images are displayed, performing the processes of:
photographing at least part of the face of the information providing medium on which the information storage media are disposed, using the photographing display apparatus,
acquiring a first image photographed by the photographing display apparatus, using the communication terminal,
transmitting the acquired first image to the server, using the communication terminal,
transmitting a second image corresponding to the first image transmitted from the communication terminal and the display coordinates for displaying the second image to the communication terminal, using the server,
displaying the second image transmitted from the server at the position based on the display coordinates of the photographing display apparatus, using the communication terminal,
reading the tag identification information from the information storage media, using the communication terminal,
transmitting the read tag identification information to the server, using the communication terminal, and
performing predetermined processing on the basis of the tag identification information transmitted from the communication terminal, using the server.

15. A program for making a communication terminal to execute the steps of:
acquiring a first image from the photographing display apparatus connected to the communication terminal,
identifying predetermined identification images in the acquired first image,
generating a space coordinate system on the basis of the relative positions of the identification images in the first image,
transmitting the coordinate range on the generated space coordinate system to the server connected to the communication terminal,
in the case that a second image and display coordinates have been transmitted from the server, displaying the second image at the position based on the display coordinates of the photographing display apparatus,
reading tag identification information from information storage media provided externally, and
transmitting the read tag identification information to the server.

16. A program for making a computer to execute the steps of:
retrieving the tag identification information, on the basis of the coordinate range transmitted from the communication terminal connected to the computer, from a tag position database in which the tag identification information and coordinates are stored so as to correspond mutually,
retrieving commodity identification information, on the basis of the retrieved tag identification information, from a corresponding commodity database in which the tag identification information and the commodity identification information are stored so as to correspond mutually,
retrieving a commodity image, on the basis of the retrieved commodity identification information, from a commodity information database in which the commodity identification information, the commodity image and the commodity image are stored so as to correspond mutually,
transmitting the retrieved commodity image and the display coordinates for displaying the commodity image to the communication terminal, and
performing predetermined processing on the basis of the tag identification information transmitted from the communication terminal.

17. A program for making a computer to execute the steps of:
identifying a predetermined identification image in the first image transmitted from the communication terminal connected to the computer,
generating a space coordinate system in the first image on the basis of the relative position of the identification image identified in the first image,
transmitting a second image corresponding to the generating space coordinate system and the display coordinates for displaying the second image to the communication terminal, and
performing predetermined processing on the basis of the tag identification information transmitted from the communication terminal.

18. The information processing system according to claim 2, wherein
the server preliminarily stores the coordinates on the space coordinate system and the second image so as to correspond mutually.

19. The information processing system according to claim 6, wherein
the server preliminarily stores the coordinates on the space coordinate system and the second image so as to correspond mutually.

20. The information processing system according to claim 2, wherein the photographing display apparatus displays the first image and the second image so as to be overlapped.

21. The information processing system according to claim 3, wherein the photographing display apparatus displays the first image and the second image so as to be overlapped.

22. The information processing system according to claim 4, wherein the photographing display apparatus displays the first image and the second image so as to be overlapped.

23. The information processing system according to claim 5, wherein the photographing display apparatus displays the first image and the second image so as to be overlapped.

24. The information processing system according to claim 6, wherein the photographing display apparatus displays the first image and the second image so as to be overlapped.

25. The information processing system according to claim 7, wherein the photographing display apparatus displays the first image and the second image so as to be overlapped.
